(19) United States
(12) Patent Application Publication
(10) Pub. No.: US 2003/0004873 A1
(43) Pub. Date: Jan. 2, 2003

(54) Gift certificate envelope system and method

(76) Inventor: Mark Matteo, Albany, NY (US)

Correspondence Address: HOFFMAN WARNICK & D'ALESSANDRO, LLC, 3 E-COMM SQUARE, ALBANY, NY, 12207

(21) Appl. No.: 09/897,178

(22) Filed: Jul. 2, 2001

(51) Int. Cl. G06F 17/60

(52) U.S. Cl. 705/40; 705/39; 705/14

(57) ABSTRACT

A third party gift certificate system and method. The gift certificate package comprises: a gift certificate printed on an exterior side of a sealed envelope, wherein the gift certificate includes a redeemable amount; and a bank check enclosed within the sealed envelope, wherein the bank check includes a payable amount. The gift certificate package is issued by a third party for a redeemable amount that is generally greater than the payable amount of the bank check. When the gift certificate is presented to a participating merchant, the participating merchant removes the bank check, thereby obtaining immediate payment. The third party profits from the difference between the redeemable amount of the gift certificate and the payable amount of the bank check.

### BACKGROUND OF THE INVENTION

1. Technical Field

The present invention relates generally to packaging and processing third party redeemable instruments, and more particularly to a system and method for issuing and processing third party gift certificates.

2. Related Art

Gift certificates have become an invaluable tool for vendors to market their goods and services. In fact, almost all retail vendors, including restaurants, department stores, boutiques, on-line stores, etc., offer some form of gift certificates. For consumers, gift certificates provide a convenient mechanism to purchase and give a gift. In particular, gift certificates not only allow a purchaser to adhere to an exact budget, but they also virtually eliminate the often difficult gift selection process.

To further the usefulness and effectiveness of gift certificates, intermediary third parties have entered the gift certificate marketplace. Specifically, third parties enter into agreements with vendors and then sell gift certificates for the participating vendors pursuant to the agreement. This then allows consumers to purchase a gift certificate for any one of a number of participating vendors (e.g., stores or restaurants) from a single third party intermediary. To further increase flexibility, the third party may offer a universal gift certificate redeemable by a number of different vendors (e.g., the gift certificate may be valid at any store in a shopping mall).

In order to profit from this third party model, the third party generally keeps a portion of the gift certificate revenue. For example, if a third party sold a $100 gift certificate for a participating vendor, the third party would collect $100 from the customer, issue a $100 gift certificate to the customer for the participating vendor, and then pay the vendor the $100 less a transaction fee (e.g., $5). Thus, under this model, the customer would receive $100 worth of goods and/or services, the third party would profit $5 for each such transaction, and the vendor would receive $95. The fact that the vendor ends up selling their goods and/or services at a slight discount can be readily justified by the vendor as a marketing cost associated with guaranteed revenue. Thus, the third party model is convenient for the customer, and profitable to both the vendor and the third party.

However, one of the drawbacks of the third party model described above is the fact that the gift certificate itself is not a liquid form of currency to the vendor. In other words, after the vendor receives the gift certificate, the vendor must look to the third party for reimbursement. This may result in a payment waiting period, and create some risk that the third party will default (thereby decreasing the value of the transaction). To alleviate this, an escrow can be set up for the vendor in order to ensure payment. However, the process of maintaining and tracking separate escrows for numerous vendors creates significant accounting overhead and costs for the third party.

Accordingly, a need exists for a system and method in which third party gift certificates (and other redeemable instruments) can be issued and processed without creating additional costs and overhead to the parties involved.

### SUMMARY OF THE INVENTION

The present invention overcomes the above-mentioned problems, as well as others, by providing a system and method for issuing redeemable instruments, such as gift certificates, in which the vendor receives immediate payment and the third party incurs little or no additional overhead.

In a first aspect, the invention provides a third party payment system, comprising: a first redeemable instrument printed on an exterior side of a sealed envelope, wherein the first redeemable instrument has a first redeemable value; and a second redeemable instrument enclosed within the sealed envelope, wherein the second redeemable instrument has a second redeemable value.

In a second aspect, the invention provides a third party gift certificate system, comprising: a gift certificate printed on an exterior side of a sealed envelope, wherein the gift certificate includes a redeemable amount; and a check enclosed within the sealed envelope, wherein the check includes a payable amount.

In a third aspect, the invention provides a a method for implementing a third party payment system, comprising the steps of: issuing a redeemable instrument to a first party for a predetermined amount, wherein the redeemable instrument is provided by a third party and is printed on an exterior side of a sealed envelope, and wherein the sealed envelope contains a negotiable instrument; guaranteeing that the redeemable instrument can be redeemed in exchange for a consideration provided by a second party equal to the predetermined amount; and reimbursing the second party by allowing the second party to remove the negotiable instrument from the sealed envelope, wherein the negotiable instrument is payable to the second party for a payable amount.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a front view of an exemplary gift certificate system in accordance with a preferred embodiment of the present invention.

FIG. 2 depicts a rear view of the exemplary gift certificate system of FIG. 1.

FIG. 3 depicts the exemplary gift certificate system of FIG. 1 being opened.

FIG. 4 depicts an enclosed negotiable instrument contained within the exemplary gift certificate system of FIG. 1.

FIG. 5 depicts a gift certificate business model in accordance with a preferred embodiment of the present invention.

### DETAILED DESCRIPTION OF THE INVENTION

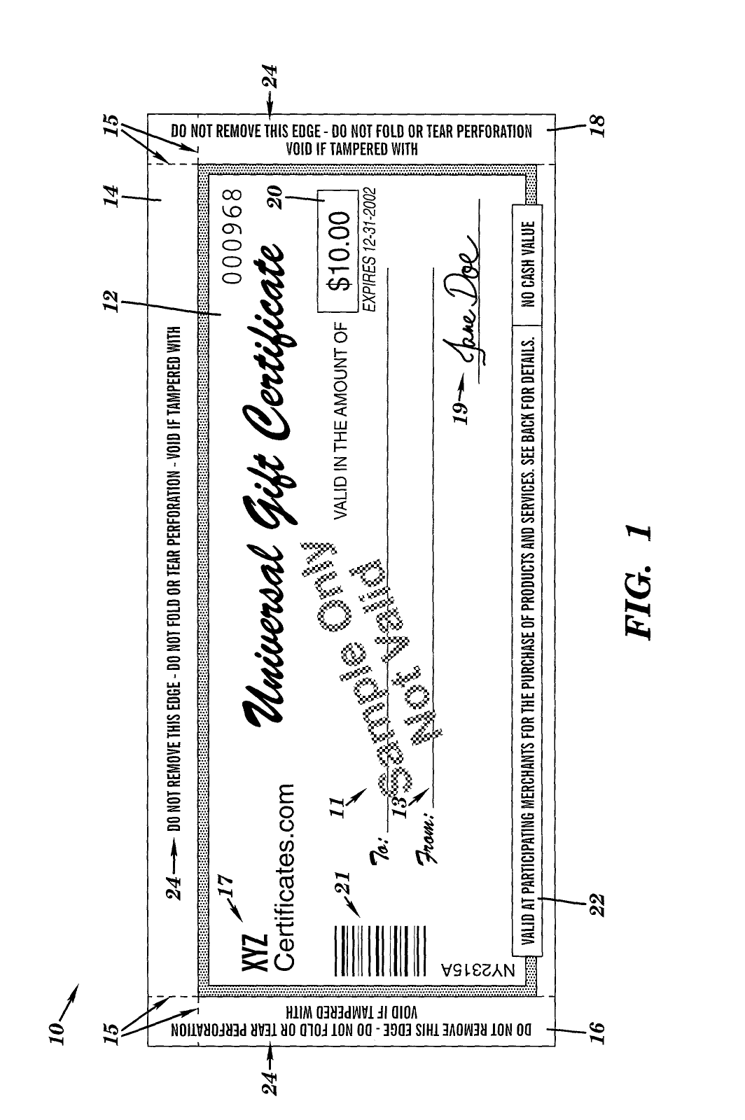

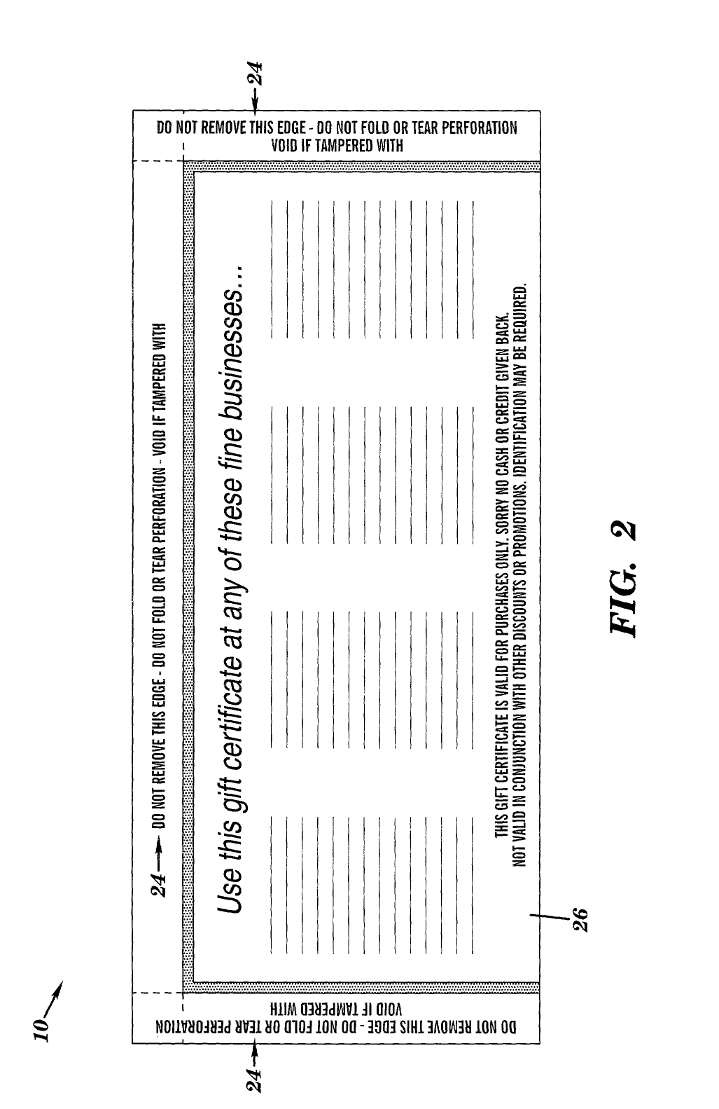

Referring now to the figures, FIG. 1 depicts an exemplary third party gift certificate system 10 issued by a third party pursuant to this invention. Gift certificate system 10 is packaged as a sealed envelope with a redeemable gift certificate 12 printed on a front side. Gift certificate 12 includes a redeemable or predetermined amount 20. The redeemable amount 20 typically reflects both the redeemable dollar value of the gift certificate, as well as the amount the purchaser paid for the gift certificate (in this case, $10). Also included on gift certificate 12 are additional written indicia. For example, gift certificate 12 includes spaces for indicating to whom the gift certificate is to be given 11; from whom the gift certificate was given 13; the name of the third party 17 who issued the gift certificate (e.g., Simply Certificates.com™); an authorized signature 19; a bar code 21; etc. Also included is information 22 regarding the vendor or vendors where the gift certificate is valid. In this case, the gift certificate is valid at a plurality of participating merchants that are shown on the rear side of the gift certificate (see FIG. 2). It should be appreciated that while this preferred embodiment comprises a universal gift certificate (i.e., it is redeemable by a plurality of participating merchants), a gift certificate redeemable by only a single merchant could likewise be implemented.

As noted above, the gift certificate system 10 comprises a sealed or enclosed envelope. The sealed envelope includes a removable top tab (or edge) 14 and removable side tabs (or edges) 16 and 18. Each tab is removable along perforations 15, thereby allowing the gift certificate envelope to be readily opened. Printed on each tab is a warning 24 that warns the gift certificate holder not to remove the tabs. If the tabs are removed by the gift certificate holder, the gift certificate is voided. Although this preferred embodiment utilizes a sealed envelope having removable tabs, any type of sealable (i.e., close-able) envelope or package could be utilized.

Referring now to FIG. 2, the back side 26 of the gift certificate system 10 is shown. As can be seen, the gift certificate is redeemable at a plurality of vendors or merchants. The back side also includes warnings 24 printed on each of the tabs. The gift certificate 12 is sold to a purchaser/giftor who, in turn, can give the gift certificate to a customer/giftee. The customer/giftee would then present the gift certificate to one of the participating vendors and redeem the gift certificate for consideration in the amount 20 listed on the front side of the gift certificate 12. Thus, in the case of a restaurant, the customer would receive a credit in the amount of the gift certificate (e.g., $10) towards the final bill.

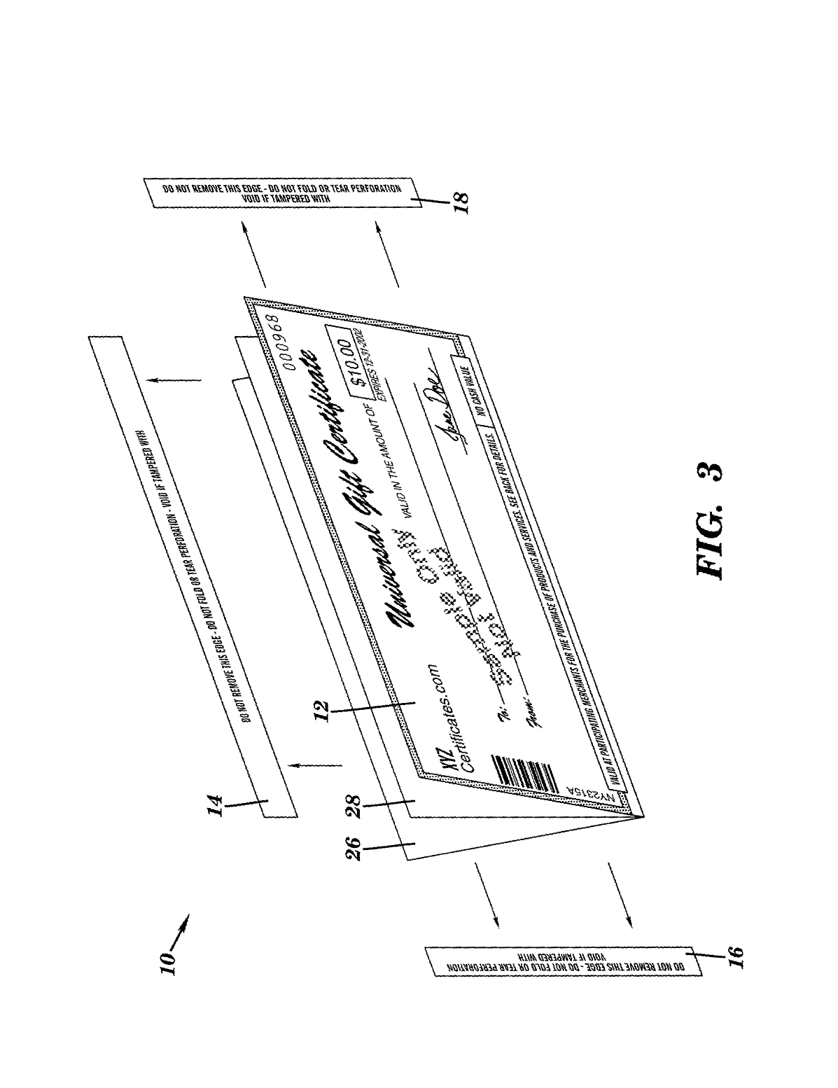

FIG. 3 depicts the sealed envelope of gift certificate system 10 being opened. Gift certificate system 10 would typically only be opened by the vendor or merchant after the gift certificate has been presented and redeemed by a customer. As shown, gift certificate system 10 is opened by removing the tabs 16, 18 and 14 and then separating the front side of the gift certificate 12 from the back side 26 to reveal an enclosed second redeemable instrument, in this case, a negotiable bank check 28.

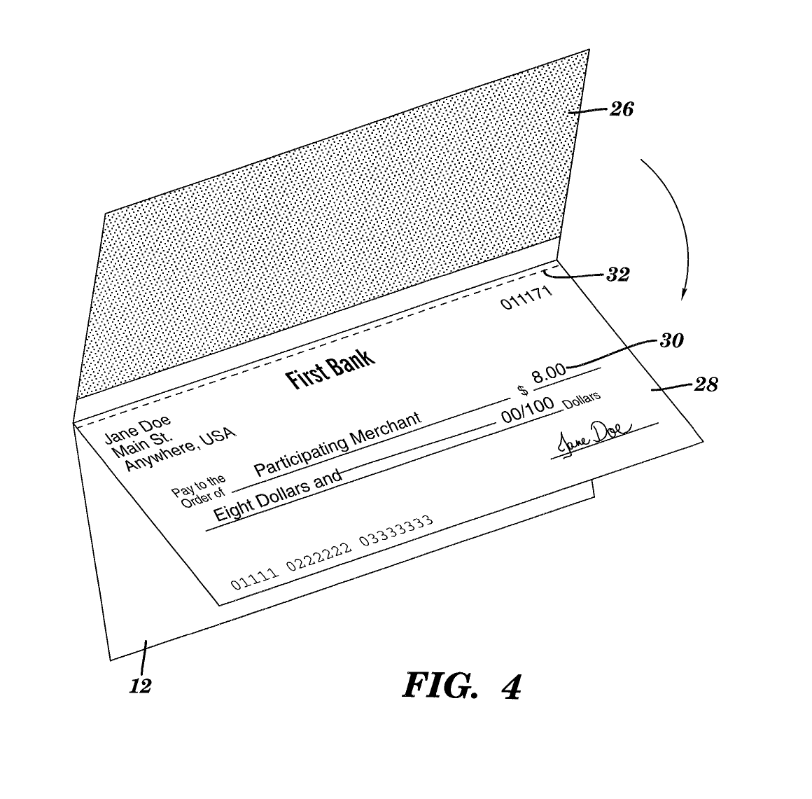

As shown in FIG. 4, bank check 28 is made payable to the participating merchant(s) for a payable amount 30. In the case of a universal gift certificate, where there are numerous participating merchants (i.e., possible payees), the check would be drafted in such a manner that the participating merchants, and only the participating merchants, could present the check for payment. Thus, the enclosed check 28 has no value to any party other than a participating merchant. Bank check 28 can be detached from the gift certificate system 10 by tearing it along perforation 32. Accordingly, when the participating merchant redeems the gift certificate 12, the merchant receives immediate reimbursement for the provided goods and services, simply by tearing open the envelope and removing bank check 28. As can be seen, the bank check 28 is made out to a payable amount (e.g., $8) that is slightly less than the gift certificate redeemable amount (e.g., $10). Accordingly, the third party that sold the gift certificate would profit 20%, or $2 from the transaction.

It should be understood that while this preferred embodiment describes a gift certificate system 10 that includes a gift certificate 12 printed on the outside of a sealed envelope, and a negotiable bank check 28 contained on the interior portion of the envelope, any type of redeemable instrument could be utilized. For the purposes of this invention, a “redeemable instrument” includes any type of gift certificate, coupon, ticket, money order, voucher, security, negotiable instrument, commercial paper, etc., (but specifically excludes postage). Thus, the instrument printed on the outside could comprise an airplane ticket, and the instrument contained on the inside could comprise a money order, etc.

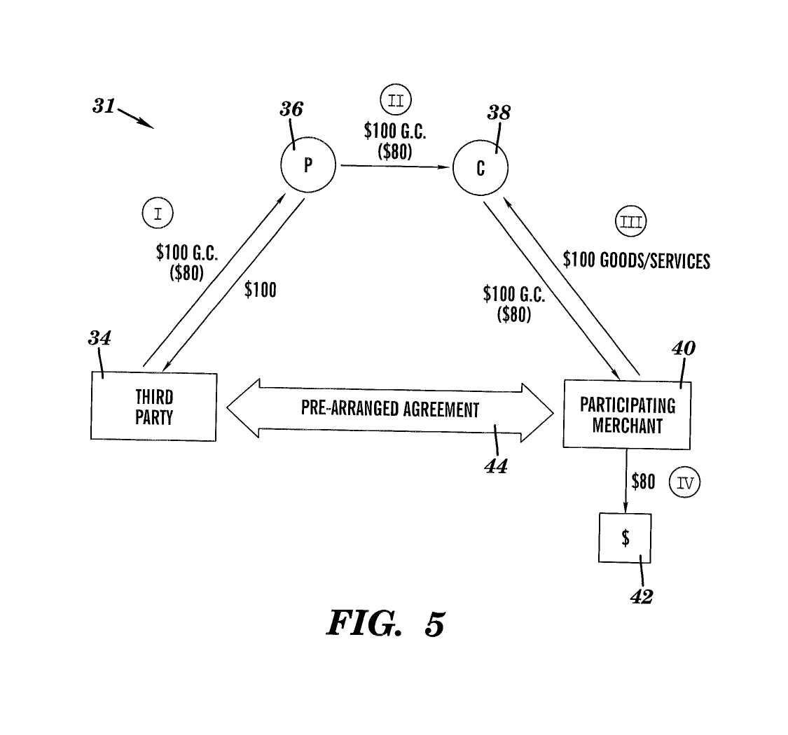

Referring now to FIG. 5, an exemplary business model flow diagram 31 is depicted. In a first step (I), a third party gift certificate issuer 34 sells a gift certificate to a purchaser for $100. Pursuant to the transaction, the purchaser 36 receives a $100 gift certificate, which contains an enclosed bank check valuing $80. In a second step (II), purchaser 36 transfers the $100 gift certificate containing the $80 bank check to a customer 38 in the form of a gift (i.e., purchaser 36 is the giftor and customer 38 is the giftee). In a next step (III), customer 38 presents and transfers the $100 gift certificate to a participating merchant 40, where it is redeemed for $100 worth of goods or services (i.e., consideration). Finally, (IV) the participating merchant 40 opens the sealed envelope, removes the $80 bank check, and presents it to a bank 42 for payment. Preferably, a prearranged agreement 44 between third party 34 and participating merchant 40 is first established in order to implement this model. For example, in this case, third party 34 and participating merchant 40 agreed that third party 34 would retain 20% of the gift certificate sale. Thus, the redeemable amount 20 of the gift certificate 12 will generally be greater than the payable amount 30 of the bank check 28.

It should be understood that the invention described here could be used for any transaction in which a third party issues any type of redeemable instrument, or in which it is merely desirable to package a second redeemable instrument inside a first redeemable instrument. Moreover, it should be understood that the dollar amounts described herein are for exemplary purposes only, and obviously other amounts could be utilized. For instance, although preferred, it is not required that the amount of the instrument on the outside of the envelope be greater than the amount of the instrument contained in the envelope. Furthermore, an explicit dollar amount need not be actually printed on one or both of the instruments (e.g., the instrument printed on the outside of the envelope could comprise an airplane ticket with no dollar amount). Thus, either instrument may have a “value” that may or may not equate to a fixed dollar amount. Finally, it should be understood that the step of gifting the redeemable instrument from purchaser 36 to customer 38 shown in FIG. 5 comprises an optional step that is not necessary to practice the invention.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A third party payment system, comprising:
a first redeemable instrument printed on an exterior side of a sealed envelope, wherein the first redeemable instrument includes a first redeemable value; and
a second redeemable instrument enclosed within the sealed envelope, wherein the second redeemable instrument includes a second redeemable value.

2. The third party payment system of claim 1, wherein the first redeemable instrument comprises a gift certificate and the first redeemable value provides an amount of the gift certificate.

3. The third party payment system of claim 2, wherein the second redeemable instrument comprises a bank check and the second redeemable value provides an amount of the bank check.

4. The third party payment system of claim 3, wherein the amount of the gift certificate is greater than the amount of the bank check.

5. The third party payment system of claim 4, wherein the gift certificate is redeemable by at least one participating merchant, and the bank check is valid only for the at least one participating merchant.

6. The third party payment system of claim 1, wherein the sealed envelope includes at least one removably perforated tab.

7. The third party payment system of claim 6, wherein a premature removal of the at least one removably perforated tab voids the first redeemable instrument.

8. The third party payment system of claim 1, wherein the second redeemable instrument is attached to an interior of the sealed envelope.

9. The third party payment system of claim 8, wherein the second redeemable instrument includes a perforated edge for removal from the interior of the sealed envelope.

10. The third party payment system of claim 1, wherein the sealed envelope includes a listing of participating merchants on a second exterior side.

11. A third party gift certificate system, comprising:
a gift certificate printed on an exterior side of a sealed envelope, wherein the gift certificate includes a redeemable amount; and
a check enclosed within the sealed envelope, wherein the check includes a payable amount.

12. The third party gift certificate system of claim 11, wherein the redeemable amount is greater than the payable amount.

13. The third party payment system of claim 11, wherein the gift certificate is redeemable by at least one participating merchant, and the bank check is valid only for the at least one participating merchant.

14. The third party payment system of claim 11, wherein the sealed envelope includes at least one removably perforated edge.

15. The third party payment system of claim 14, wherein a premature removal of the at least one removably perforated edge voids the gift certificate.

16. The third party payment system of claim 11, wherein the bank check is attached to an interior side of the sealed envelope.

17. The third party payment system of claim 16, wherein the bank check includes a perforated edge for removal from the interior side of the sealed envelope.

18. The third party payment system of claim 11, wherein the sealed envelope includes a listing of participating merchants on a second exterior side.

19. A method for implementing a third party payment system, comprising the steps of:
issuing a redeemable instrument to a first party for a predetermined amount, wherein the redeemable instrument is provided by a third party and is printed on an exterior side of a sealed envelope, and wherein the sealed envelope contains a negotiable instrument;
guaranteeing that the redeemable instrument can be redeemed in exchange for a consideration provided by a second party equal to the predetermined amount; and
reimbursing the second party by allowing the second party to remove the negotiable instrument from the sealed envelope, wherein the negotiable instrument is payable to the second party for a payable amount.

20. The method of claim 19, wherein the guaranteeing step includes the step of obtaining agreement between the second and third party regarding the payable amount of the negotiable instrument.

21. The method of claim 19, after the issuing step, comprising the further steps of:
allowing the redeemable instrument to be gifted from the first party to a giftee; and
allowing the giftee to redeem the redeemable instrument with the second party.

22. The method of claim 19, wherein the redeemable instrument comprises a gift certificate and the negotiable instrument comprises a bank check.

23. The method of claim 19, wherein the first party comprises a customer, and the second party comprises a participating merchant.

24. The method of claim 19, wherein the payable amount of the negotiable instrument is less than the predetermined amount of the redeemable instrument.
